(19) United States
(12) Patent Application Publication
(10) Pub. No.: US 2019/0304388 A1
(43) Pub. Date: Oct. 3, 2019

(54) DRIVING CIRCUIT STRUCTURE AND DISPLAY DEVICE

(71) Applicants: HKC Corporation Limited, Baoan Dist., Shenzhen (CN); Chongqing HKC Optoelectronics Technology Co., Ltd., Chongqing (CN)

(72) Inventor: YU-JEN CHEN, Chongqing (CN)

(21) Appl. No.: 15/744,851

(22) PCT Filed: Jul. 25, 2017
(86) PCT No.: PCT/CN2017/094283

§ 371 Date: Jan. 15, 2018

(30) Foreign Application Priority Data
Dec. 19, 2016 (CN) 201611179077.5

(51) Int. Cl. G09G 3/36; G09G 3/20; G02F 1/1333; G02F 1/1362

(52) U.S. Cl. CPC G09G 3/3611; G02F 1/136286; G02F 1/133305; G09G 3/2092

(57) ABSTRACT

A driving circuit structure and a display device are provided. The driving circuit structure includes: a display panel (10); a first driving circuit board module (20) including a control driving circuit board (210) and a plurality of first source driving flexible boards (230) with source driver IC (231) disposed thereon. The control driving circuit board (210) outputs a control signal; and a second driving circuit board module (30) including a source driving circuit board (310) and a plurality of second source driving flexible boards (330) with source driver IC (331) disposed thereon. The source driving flexible board (230) is connected to the second source driving flexible board (330) correspondingly through wirings on the display panel (10); and the first source driving flexible board (230) transmits the received control signal to the source driving circuit board (310) through the display panel (10) and the second source driving flexible board (330).

### CROSS-REFERENCE TO RELATED APPLICATION

This application claims priority from China Patent Application No. 2016111790775 filed on Dec. 19, 2016, and entitled “DRIVING CIRCUIT STRUCTURE OF DISPLAY PANEL AND DISPLAY DEVICE” at State Intellectual Property Office of the P.R.C, the entirety of which is hereby incorporated by reference.

### BACKGROUND OF THE INVENTION

### 1. Field of the Invention

The present invention relates to the display device technology, and more particularly to a driving circuit structure and a display device.

### 2. DESCRIPTION OF THE RELATED ART

In recent years, flat display devices are flourishing along with the maturing of photoelectric technologies and semiconductor manufacturing technologies. Wherein, liquid crystal display (LCD) is a flat panel display (FPD) displaying images by utilizing the properties of display materials, which gradually replaces traditional cathode ray tube display devices and becomes a mainstream of display device products because of the advantages such as low-voltage operation, non-radiation scattering, light weight and small size.

The driving method of a large-size display panel of a general display device is to transmit control signals to two x-axis-driving circuit boards connected with each other, by a connector and a flexible flat cable (FFC) respectively; and to drive the display panels connected with each other, by a source driver IC on the x-axis-driving circuit boards. Perhaps, the method is to integer a control circuit board and the x-axis-driving circuit board to form a driving control board, which is connected to the x-axis-driving circuit board by the flexible flat cable (FFC) and the connector. However, several circuit boards and connectors are required in these structures, of which the cost of materials and time are too high.

### SUMMARY OF THE INVENTION

According to various embodiments of the present application, a driving circuit structure and a display device are provided.

A driving circuit structure, comprising: a display panel; a first driving circuit board module electrically connected to the display panel, comprising a control driving circuit board and a plurality of first source driving flexible boards with source driver IC disposed thereon; wherein the control driving circuit board outputs a control signal and transmits the control signal to the display panel through the first source driving flexible board; a second driving circuit board module electrically connected to the display panel, comprising a source driving circuit board, a plurality of second source driving flexible boards with the source driver IC disposed thereon; wherein the source driver IC drives the display panel; wherein the first source driving flexible board and the second source driving flexible board disposed adjacently are connected correspondingly through a wiring on the display panel; and wherein the first source driving flexible board transmits the received control signal to the source driving circuit board through the display panel and the second source driving flexible board.

A display device, comprising a backlight module and a driving circuit structure; wherein the driver circuit structure is positioned at a side of a light exit surface of the backlight module.

The details of the one or more embodiments of the present invention will be described in following accompanying drawings and descriptions. The purposes, advantages and other features will become apparent from the specification, accompanying drawings and claims.

### BRIEF DESCRIPTION OF THE DRAWINGS

The accompanying drawings required for describing embodiments or prior arts will be briefly described herein, for explaining the technical solutions of the embodiments of the present application or prior art more clearly. Apparently, the accompanying drawings in the following description are merely some embodiments of the present application. A person having ordinary skill in the art is able to obtain other drawings according to these appending drawings without under the premise of paying creative labor. In the accompanying drawings:

FIG. 1 is a schematic view of the driving circuit structure in an embodiment;

FIG. 2 is a schematic view of the first source driving flexible board in FIG. 1;

FIG. 3 is a schematic view of the second source driving flexible board in FIG. 1;

FIG. 4 is a schematic view of a display panel in an embodiment; and

FIG. 5 is a schematic view of partial enlargement of the driving circuit structure of FIG. 1.

### DESCRIPTION OF THE PREFERRED EMBODIMENTS

Hereinafter, the present application will be described taken in conjunction with the accompanying drawings, for ease of understanding the present application. However, the present application is able to be implemented by various forms, but is not limited to the embodiments set forth herein. On the contrary, the purpose of providing these embodiments is to make the disclosure of the present application being understood more clearly and comprehensively.

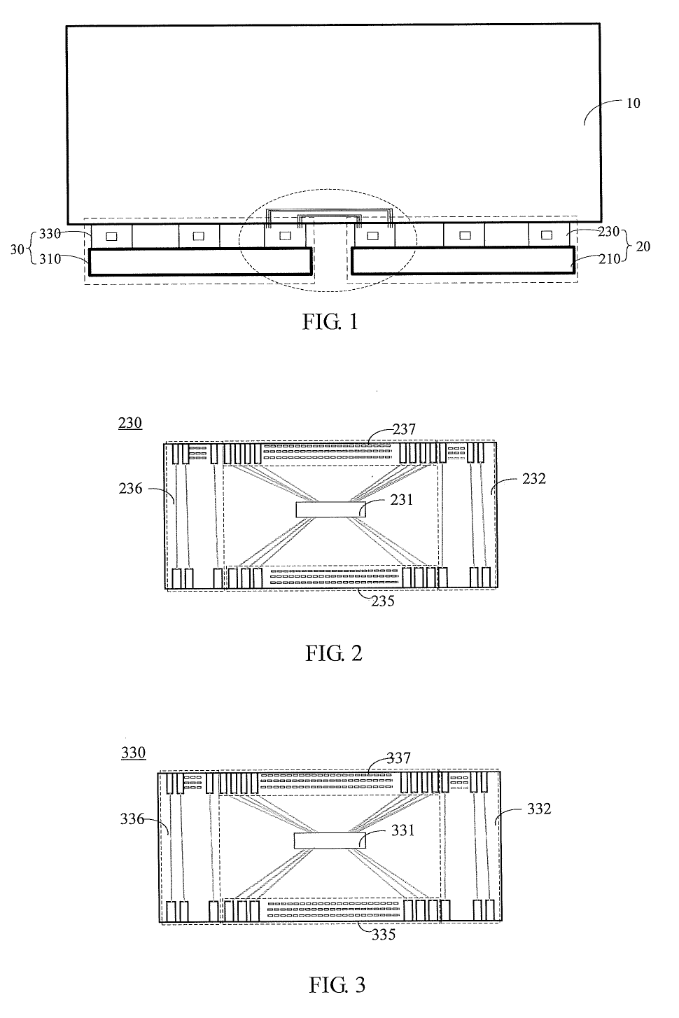

Referring to FIG. 1, a driving circuit structure comprises a display panel 10, and further comprises a first driving circuit board module 20 disposed at the same side as the display panel 10 and a second driving circuit board module 30. The first driving circuit board module 20 and the second driving circuit board module 30 are electrically connected to the display panel 10 individually. Wherein, referring to FIGS. 2 and 3, the first driving circuit board module 20 comprises a control driving circuit board 210 and a plurality of first source driving flexible boards 230 with source driver ICs 231 disposed thereon. The second driving circuit board module 30 comprises a source driving circuit board 310 and a plurality of second source driving flexible boards 330 with source driver ICs 331 disposed thereon. The first source driving flexible board 230 and the second source driving flexible board 330 disposed adjacently are connected correspondingly through a wiring on the display panel 10. The first source driving flexible board 230 transmits a received control signal outputted by the control driving circuit board 210 to the source driving circuit board 310 through the wiring and the second source driving flexible board 330.

In terms of a large-size display panel 10, two driving circuit boards are required, that is, the control driving circuit board 210 and the source driving circuit board 310 in an embodiment, which may ensure that the driving circuit board may not be damaged by the bending and deformation caused by the excess length. The first source driving flexible board 230 and the second source diving flexible board 330 disposed adjacently are connected correspondingly through the wiring on the display panel 10, and may transmit the signal outputted by the control driving circuit board 210 to the source driving circuit board 310 through the first source driving flexible board 230, the display panel 10 and the second source driving flexible board 330 in order. The material cost and manual assembly cost of the flexible flat wiring and two connectors may be economized in comparison with traditional signal transmitting methods. Further, the whole structure is also simplified.

Wherein, the control driving circuit board 210 outputs the control signal and transmits the control signal to the display panel 10 through the first source driving flexible board 230. In an embodiment, the control driving circuit board 210 integers a traditional control board and a source driving board together. Wherein, a DCDC power module (for generating a voltage provided to a voltage and timing control module chip of the display panel 10) of a control board (CB), a P-gamma module (for programing gamma correction buffering circuit chip) and a control module on a source board for outputting the source driving signal which drives the source driver IC are integrated on the control driving circuit board 210.

The control diving circuit board 210, the first source driving flexible board 230 and the display panel 10 are connected in order. The control driving circuit board 210 outputs and transmits the control signal to the display panel 10 through the first source driving flexible board 230, and transmits the source driving signal to the source driver IC 231 on the first source driving flexible board 230 through the first source driving flexible board 230. Further, the source driver IC 231 drives the display panel 10.

The source driving circuit board 310 outputs the source driving signal and transmits the source driving signal to the source driver IC 331 on the second source driving flexible board 330. Further, the source driver IC 331 drives the display panel 10.

Referring to FIG. 2, a first by-pass wiring region 232 and a second by-pass wiring region 236 are disposed individually at the two ends of the first source driving flexible board 230. Wherein, the first by-pass wiring region 232 and the second by-pass wiring region 236 are positioned individually at the two ends of the first source driving flexible board 230.

Referring to FIG. 3, a third by-pass wiring region 332 and a fourth by-pass wiring region 336 are disposed individually at the two ends of the second source driving flexible 330. The third by-pass wiring region 332 and the fourth by-pass wiring region 336 are positioned individually at the two ends of the second source driving flexible board 330. In the first source driving flexible board 230 and the second source driving flexible board 330 disposed adjacently, the second by-pass wiring region 236 and the third by-pass wiring region 332 are disposed adjacently.

In particular, the first source driving flexible board 230 and the second source driving flexible board 330 disposed adjacently are connected correspondingly through the wiring of the display panel 10. Wherein, the second by-pass wiring region 236 of the first source driving flexible board 230 is connected to the third by-pass wiring region 332 of the second source driving flexible board 330 correspondingly through the wiring of the display panel 10.

In an embodiment, in the first source driving flexible board 230 and the second source driving flexible board 330, the first by-pass wiring region 232 of the first source driving flexible board 230 may further be connected to the fourth by-pass wiring region 336 of the second driving flexible board 330 through the wiring of the display panel 10, depending on substantially requirements. This increases the signal transmitting channels, and provides the basis for multi-signal transmission.

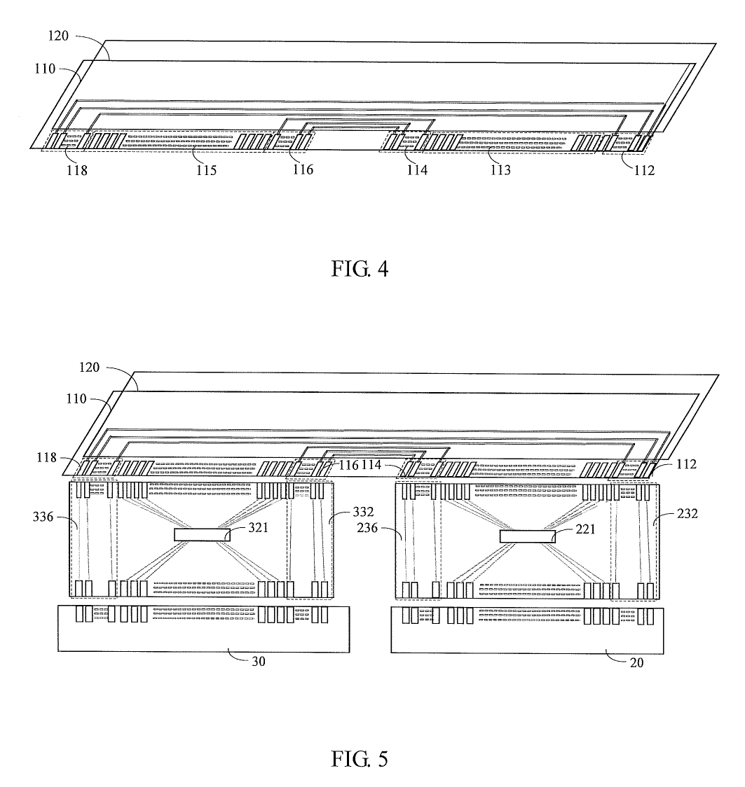

Referring to FIG. 4, the display panel 10 comprises a first metal layer 110 and a second metal layer 120. A first attaching region 112, a second attaching region 114, a third attaching region 116 and a fourth attaching region 118 are disposed on the first metal layer 110 in order.

Referring FIG. 5, wherein the first attaching region 112 is attached to and connected to the first by-pass wiring region 232 correspondingly; the second attaching region 114 is attached to and connected to the second by-pass wiring region 236 correspondingly; the third attaching 116 is attached to and connected to the third by-pass wiring region 332 correspondingly; and the fourth attaching region 118 is attaching to and connected to the fourth by-pass wiring region 336 correspondingly.

Gold finger pins are disposed at the first by-pass wiring region 232, the second by-pass wiring region 236, the third by-pass wiring region 332 and the fourth by-pass wiring region 336. A plurality of the gold finger pins are disposed at the first attaching region 112, the second attaching region 114, the third attaching region 116 and the fourth attaching region 118.

In particular, the gold finger pins of the first by-pass wiring region 232 and the second by-pass wiring region 236 are arranged at the two sides of the first source driving flexible board 230. Wherein, a first side of the first source driving flexible board 230 is adjacent to the control driving circuit board 210; and a second side of the first source driving flexible board 230 is adjacent to the display panel 10. The gold finger pins arranged at the first side of the first source driving flexible 230 are attached to and connected to the control driving circuit board 210. Wherein, the gold finger pins of the first by-pass wiring region 232 are attached to and connected to the gold finger pins of the first attaching region 112 of the display panel correspondingly; and the gold finger pins of the second by-pass wiring region 236 are attached to and connected to the gold finger pins of the second attaching region 114 of the display panel 10 correspondingly. The gold finger pins arranged at the second side of the first source driving flexible board 230 are attached to and connected to the first metal layer 110 of the display panel 10 correspondingly.

Correspondingly, the gold finger pins of third by-pass wiring region 332 and the fourth by-pass wiring region 336 are arranged at the two sides of the second source driving flexible board 330. Wherein, a first side of the second source driving flexible board 330 is adjacent to the source driving circuit board 310; and a second side of the second source driving flexible board 330 is adjacent to the display panel 10. The gold finger pins arranged at the first side of the second source driving flexible boar 330 are attached to and connected to the source driving circuit board 310. Wherein, the gold finger pins of the third by-pass wiring region 332 are attached to and connected to the gold finger pins of the third attaching region 116 of the display panel 10 correspondingly; and the gold finger pins of the fourth by-pass wiring region 336 are attached to and connected to the fourth attaching region 118 of the display panel 10 correspondingly. The gold finger pins arranged at the second side of the second source driving flexible board 330 are attached to and connected to the first metal layer 110 of the display panel 10 correspondingly.

Metal wirings are disposed on the second metal layer 120. The metal wiring is extended to the gold finger pins of the first metal layer 110 through holes. The gold finger pins of the first attaching region 112 are connected to the gold finger pins of the fourth attaching region 118 correspondingly through the metal wiring. The gold finger pins of the second attaching region 114 are connected to the gold finger pins of the third attaching region 116 correspondingly through the metal wiring.

The material cost and manual assembly cost of the flexible flat wiring and two connectors may be economized in comparison with traditional signal transmitting methods. Further, the whole structure is also simplified.

In an embodiment, referring to FIG. 2, a first input wiring region 235 and a first output wiring region 237 are further disposed on the first source driving flexible board 230. The first input wiring region 235 and the first output wiring region 237 are disposed between the first by-pass wiring region 232 and the second by-pass wiring region 236 correspondingly. The control driving circuit board 210 transmits the control signal to the source driver IC 231 through the first input wiring region 235; and a voltage signal outputted by the source driver IC 231 is transmitted to the display panel 10 through the first input wiring region 237.

In an embodiment, referring to FIG. 3, a second input wiring region 335 and a second output wiring region 337 are further disposed on the second source driving flexible board 330. The second input wiring region 335 and the second output wiring region 337 are disposed between the third by-pass wiring region 332 and the fourth by-pass wiring region 336 correspondingly. The source driver circuit board 310 transmits the source driving signal to the source driver IC 331 through the second input wiring region 335; and a voltage signal outputted by the source driver IC 331 is transmitted to the display panel 10 through the second output wiring region 337. Wherein, a plurality of gold fingers are also disposed at the first input wiring region 235, the first output wiring region 237, the second input wiring region 335 and the second output wiring region 337. The number of the gold fingers and the distances therebetween may be configured depending on the substantially requirements. In an embodiment, the gold fingers of the first input wiring region 335 and the first output wiring region 237 are disposed and spaced apart at an equal distance correspondingly; and the gold fingers in the second input wiring region 335 and the second output wiring region 337 are disposed and spaced apart at an equal distance correspondingly.

Correspondingly, a first input patch region 113 and a second input patch region 115 are further disposed on the first metal layer 110 of the display panel 10. Wherein, each of the gold finger so f the first input wiring region 235 is attached to and connected to that of the first input patch region 113 correspondingly; each of the gold fingers of the second input wiring region 335 is attached to and connected to that of the second input patch region 115 correspondingly; and each of the gold fingers on the first input patch region 113 is connected to the second input patch region 115 correspondingly through the metal wiring on the second metal layer 120.

In an embodiment, the number of the first source driving flexible board 230 is equal to the number of the second source driving flexible board 300. Wherein, both of the numbers of first source driving flexible board 230 and the second source driving flexible board 330 are three. In other embodiments, the numbers of the first source driving flexible board 230 and the second source driving flexible board 330 may be configured depending on the substantially requirements, and may be not equal to each other.

In an embodiment, the source driver IC 231 disposed on the first source driving flexible board 230 is the same as the source driver IC 331 disposed on the second source driving flexible board 330. Further, the outputted signal strength of each of the source driver ICs (221, 321) is the same. Since the signal strength outputted from the source driver ICs are the same, the obvious splitting line phenomenon (H-block issue or Block Dim phenomenon) between each of the first source driving flexible boards 230 and the second source driving flexible boards 330 of the display panel 10 may be eliminated, so as to improve the display quality.

In an embodiment, the driving circuit structure further comprises a third driving circuit board module (not shown in the drawings). The third driving circuit board module and the first driving circuit board module do not positioned at the same side of the display panel 10; the third driving circuit board module comprises a gate driving circuit board and a plurality of gate driving flexible boards with gate driver ICs disposed thereon. The gate driving circuit board is connected to the display panel 10 through the gate driving flexible board.

A display device (not shown in the drawings) comprises a backlight module and further comprises a driving circuit structure. The driving circuit structure is positioned at a side of a light exit surface of the backlight module.

The display device of the present embodiment comprises a driving circuit structure and a backlight module. The driving circuit structure is disposed at a side of the backlight module. In particular, the driving circuit structure is configured at a light exit surface of the backlight module. The backlight module of the present embodiment utilizes an edge-lighting type design as an example. However, when the size of the display device is 37 or more, the backlight 40 usually utilizes a direct-lighting type design. In addition, the display device may further comprise a front frame (not shown in the drawings) so that the driving circuit structure may be configured on the backlight module more stably.

It should be understood that the exemplary embodiments described therein should be considered in a descriptive sense only and not for purposes of limitation. Descriptions of features or aspects within each embodiment should typically be considered as available for other similar features or aspects in other embodiments.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A driving circuit structure, comprising:
a display panel;
a first driving circuit board module electrically connected to the display panel, and comprising a control driving circuit board and a plurality of first source driving flexible boards with source driver IC disposed thereon; wherein the control driving circuit board outputs a control signal and transmits the control signal to the display panel through the first source driving flexible board;
a second driving circuit board module electrically connected to the display panel, and comprising a source driving circuit board, a plurality of second source driving flexible boards with source driver IC disposed thereon; wherein the source driving circuit board outputs a source driving signal and transmits the source driving signal to the source driver IC on the second source driving flexible board; and wherein the source driver IC drives the display panel;
wherein the first source driving flexible board and the second source driving flexible board disposed adjacently are connected correspondingly by a wiring on the display panel; and
wherein the first source driving flexible board transmits the received control signal to the source driving circuit board through the display panel and the second source driving flexible board.

2. The driving circuit structure of claim 1, wherein
a first by-pass wiring region and a second by-pass wiring region are disposed at two ends of the first source driving flexible board individually;
a third by-pass wiring region and a fourth by-pass wiring region are disposed at two ends of the second source driving flexible board individually;
the second by-pass wiring region is disposed adjacent to the third by-pass wiring region, within the first source driving flexible board and the second source driving flexible board disposed adjacently; wherein the second by-pass wiring region is connected to the third by-pass wiring region correspondingly through the wiring of the display panel.

3. The driving circuit structure of claim 2, wherein the first by-pass wiring region is connected to the fourth by-pass wiring region correspondingly through the wiring of the display panel, within the first source driving flexible board and the second source driving flexible board disposed adjacently.

4. The driving circuit structure of claim 2, wherein a gold finger pin is disposed in the first by-pass wiring region, the second by-pass wiring region, the third by-pass wiring region and the fourth by-pass wiring region; wherein
the gold finger pin of the first source driving flexible board is used for attaching to and connecting to the control driving circuit board and the display panel individually; and
the gold finger pin of the second source driving flexible board is used for attaching to and connecting to the source driving circuit board and the display panel.

5. The driving circuit structure of claim 4, wherein
the display panel comprises a first metal layer and a second metal layer;
a first attaching region, a second attaching region, a third attaching region and a fourth attaching region are disposed in order on the first metal layer;
wherein the first attaching region is attached to and connected to the first by-pass wiring region correspondingly; the second attaching region is attached to and connected to the second by-pass wiring region correspondingly; the third attaching region is attached to and connected to the third by-pass wiring region correspondingly; and the fourth attaching region is attached to and connected to the fourth by-pass wiring region correspondingly;
wherein a metal wiring is disposed on the second metal layer;
wherein the first attaching region is attached to and connected to the fourth attaching region correspondingly through the metal wiring; and
wherein the second attaching region is attached to and connected to the third attaching region correspondingly through the metal wiring.

6. The driving circuit structure of claim 5, wherein a plurality of gold finger pins are disposed in the first attaching region, the second attaching region, the third attaching region and the fourth attaching region.

7. The driving circuit structure of claim 2, wherein
a first input wiring region and a first output wiring region are disposed on the first source driving flexible board; the first input wiring region and the first output wiring region are disposed between the first by-pass wiring region and the second by-pass wiring region correspondingly; the control driving circuit board transmits the control signal to the source driver IC through the first input wiring region; and a voltage signal outputted by the source driver IC is transmitted to the display panel through the first output wiring region; and
a second input wiring region and a second output wiring region are disposed on the second source driving flexible board; the second input wiring region and the second output wiring region are disposed between the third by-pass wiring region and the fourth by-pass wiring region correspondingly; the source driving circuit board transmits the source driving signal to the source driver IC through the second input wiring region; and the voltage signal outputted by the source driver IC is transmitted to the display panel through the second output wiring region.

8. The driving circuit structure of claim 7, wherein a plurality of the gold fingers are disposed in the first input wiring region, the first output wiring region, the second input wiring region and the second output wiring region individually; wherein
the gold fingers of the first input wiring region and the first output wiring region are disposed and spaced apart at an equal distance correspondingly; and
the gold fingers of the second input wiring region and the second output wiring region are disposed and spaced apart at an equal distance correspondingly.

9. The driving circuit structure of claim 8, wherein a first input patch region and a second input patch region are disposed on the first metal layer of the display panel;
wherein the first input patch region is attached to and connected to the first input wiring region correspondingly; and
the second input patch region is attached to and connected to the second input wiring region correspondingly.

10. The driving circuit structure of claim 1, wherein a number of the first source driving flexible board is the same as a number of the second source driving flexible board.

11. The driving circuit structure of claim 10, wherein both of the numbers of the first source driving flexible board and the second source driving flexible board are three.

12. The driving circuit structure of claim 1, wherein the source driver IC disposed at the first source driving flexible board is the same as the source driver IC disposed at the second source driving flexible board; and the strength of the signal outputted from each of the source driver ICs are the same.

13. The driving circuit structure of claim 1, further comprising a third driving circuit board module; wherein
the third driving circuit board module comprises a gate driving circuit board and a plurality of gate driving flexible boards with a gate driver IC disposed thereon; and
the gate driving circuit board is connected to the display panel through the gate driving flexible board.

14. A display device, comprising a backlight module and a driving circuit structure of any one of the claims 1-13; wherein the driver circuit structure is positioned at a side of a light exit surface of the backlight module.
